(19) United States
(12) Patent Application Publication
(10) Pub. No.: US 2025/0226587 A1
(43) Pub. Date: Jul. 10, 2025

(54) ANTENNA FOR RADIO FREQUENCY ATTENUATING ENCLOSURE

(71) Applicants: HID Global Corp., Austin, TX (US); ASSA Abloy AB, Stockholm (SE)

(72) Inventors: Robert Oberle, Emmaus, PA (US); Mohammad Abedian, Guildford (GB); Urs Furter, Noville (CH)

(21) Appl. No.: 18/981,832

(22) Filed: Dec. 16, 2024

Related U.S. Application Data
(60) Provisional application No. 63/619,043, filed on Jan. 9, 2024.

(51) Int. Cl. H01Q 13/18; G06K 7/10; H01Q 1/22; H01Q 5/307; H01Q 5/48

(52) U.S. Cl. CPC H01Q 13/18; G06K 7/10316; H01Q 1/2208; H01Q 5/307; H01Q 5/48

(57) ABSTRACT

A method and system for an antenna may provide improved wireless communication through a radio frequency (RF) attenuating enclosure. An external antenna positioned outside the enclosure receives RF signals from an RF identification (RFID) reader or another wireless device located externally. These signals may be coupled to an internal antenna located inside the sealed enclosure. The internal antenna may use the coupled RF signals to communicate with electronic tags, sensors, or other RF devices within the enclosure. Return wireless signals from the internal components may be coupled back through the antennas and connector to the external device. The RF coupling enables wireless signal penetration through the enclosure without requiring physical openings in the sealed shielding sufficiently large to allow transmission of RF signals. This allows electronic monitoring of conditions within a fully shielded enclosure for various applications, such as autoclave sterilization monitors in surgical kits.

### PRIORITY APPLICATION

This application claims priority to U.S. Provisional Patent Application Ser. No. 63/619,043, filed on Jan. 9, 2024, the disclosure of which is incorporated by reference herein in its entirety.

### TECHNICAL FIELD

Embodiments described herein generally relate to use of radio frequency identification (RFID) within a radio frequency (RF) attenuating enclosure.

### BACKGROUND

RFID technology allows objects to be identified wirelessly using radio waves. A typical RFID system may include an RFID reader device and one or more RFID tags. In operation, the RFID reader emits an RF signal that are received by nearby RFID tags. The RFID tags include an antenna that receives the RF signal. The RFID tag then modulates and reflects the RFID signal back to the RFID reader. The return RFID signal may be used to identify the RFID tag, such as by providing unique identification data. The RFID tags may also use energy from the RF signal to power the RFID signal-modulation and reflected signal broadcasting circuitry.

RFID systems may operate at various radio frequency bands, and the selected RFID band may depend on the target application. Low frequency RFID systems may operate around 125-134 kHz, and may be used for short read ranges (e.g., 0-10 cm) such as for door access control cards. High frequency RFID systems may operate around 13.56 MHz, and may provide longer read ranges (e.g., 0-2 meters) such as for inventory tracking. Ultra-high frequency (UHF) RFID systems may operate around 860-960 MHz, and may achieve longer read ranges (e.g., 1-12 meters) such as for used in supply chain management. These UHF RFID systems may typically operate around 900 MHZ, may be collectively referred to as 900 MHZ RFID systems.

RFID technology is used in various applications, such as access control, asset tracking, inventory management, supply chain automation, and other applications. RFID technology provides a wireless means of identification and data capture that provides advantages over tracking solutions that require line-of-sight, such as barcode scanning. However, RFID performance may be affected by environmental conditions, such as interference from nearby surfaces that attenuate or absorb RF signals (e.g., metal, water).

### BRIEF SUMMARY

The following presents a simplified summary of one or more embodiments of the present disclosure to provide a basic understanding of such embodiments. This summary is not an extensive overview of all contemplated embodiments, and is intended to neither identify key or critical elements of all embodiments, nor delineate the scope of any or all embodiments.

In some aspects, the techniques described herein relate to a passive antenna system for reading radio frequency tags inside a metal enclosure, the passive antenna system including: an external antenna disposed outside a metal enclosure; an internal antenna disposed inside the metal enclosure; a coupler between the external antenna and the internal antenna, the coupler configured to convey radio frequency (RF) signals between the external antenna and the internal antenna; wherein the external antenna is configured to convey an RF identification (RFID) signal from an RFID reader positioned outside the metal enclosure through the coupler to the internal antenna; and wherein the internal antenna is configured to reradiate the RFID signal to an RFID tag inside the metal enclosure, receive a return RFID signal from the RFID tag, and couple the return RFID signal to the external antenna.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the scope of the present disclosure. Accordingly, the drawings and detailed description are to be regarded as illustrative in nature and not restrictive.

### BRIEF DESCRIPTION OF THE DRAWINGS

In the drawings, which are not necessarily drawn to scale, like numerals may describe similar components in different views. Like numerals that have different letter suffixes may represent different instances of similar components. Some embodiments are illustrated by way of example, and not limitation, in the figures of the accompanying drawings:

FIG. 1 illustrates an example first antenna system for wireless communication through an RF-attenuating enclosure.

FIG. 2 illustrates a second example antenna system for wireless communication through an RF-attenuating enclosure.

FIG. 3 illustrates a third example antenna system for wireless communication through an RF-attenuating enclosure.

FIG. 4 illustrates an example method for reading RFID tags inside a metal enclosure.

FIG. 5 illustrates a block diagram schematic of various components of an example reader, such as may be used with the antenna systems and methods discussed herein.

### DETAILED DESCRIPTION

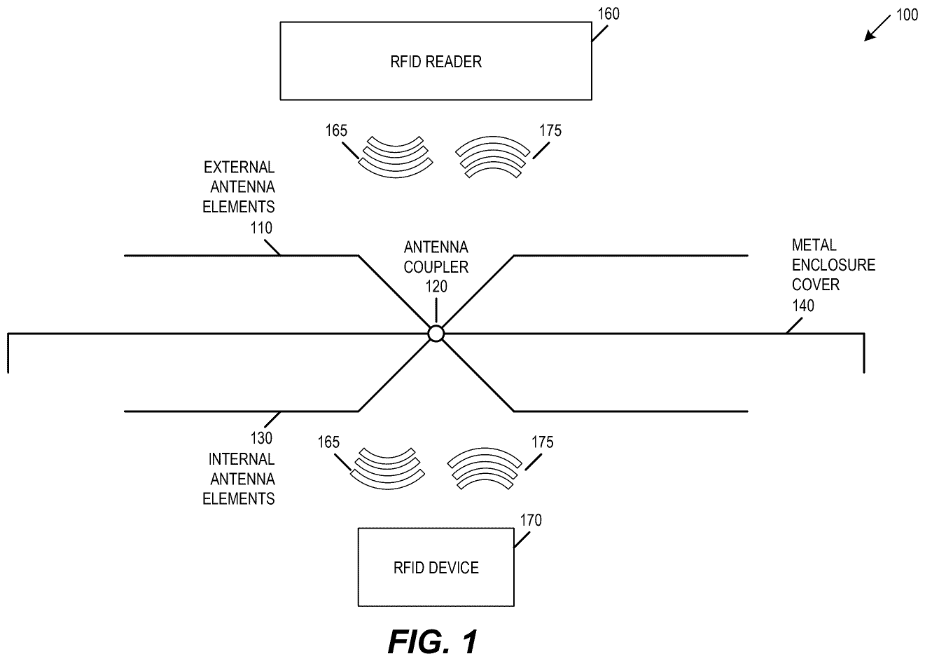

FIG. 1 illustrates an example first antenna system 100 for wireless communication through an RF-attenuating enclosure. The antenna system 100 includes external antenna elements 110 positioned outside a metal enclosure cover 140. The external antenna elements 110 are connected through an antenna coupler 120 to internal antenna elements 130 positioned inside the metal enclosure cover 140. The metal enclosure cover 140 creates a sealed enclosure that reduces or eliminates the ability of RF signals to penetrate the enclosure. In certain examples, the metal enclosure cover 140 may form a Faraday cage type enclosure that substantially attenuates or prevents passage of RF signals.

The external antenna elements 110 are configured to receive incoming wireless signals from an external source located outside the enclosure, such as an RFID reader device 160 sending an RF interrogation signal 165. The external antenna elements 110 then conveys the RF interrogation signal 165 through the antenna coupler 120 to the internal antenna elements 130, which reradiates the RF interrogation signal 165 to an RFID device 170 within the metal enclosure. The RFID device 170 may receive the RF interrogation signal 165 and generate a return RFID signal 175. In an example, the return RFID signal 175 may include a backscattered signal generated by RFID circuitry within the RFID device 170. The internal antenna elements 130 may then receive a return RFID signal 175 generated by the RFID device 170, and convey the return RFID signal 175 through the antenna coupler 120 to the external antenna elements 110. The external antenna elements 110 may then broadcast the return RFID signal back to the RFID reader device 160.

The external antenna elements 110 and internal antenna elements 130 are electrically or electromagnetically coupled to enable conveyance of wireless RFID signals into and out of the sealed metal enclosure across the enclosure barrier rather than by radiation through the barrier material. This coupling may be achieved capacitively, inductively, or conductively, and may be selected based on an intended deployment environment or application. The bidirectional wireless RFID signal transmission through the metal enclosure provided by the antenna system 100 allows wireless communication, wireless control, wireless telemetry, or wireless status monitoring of components or conditions existing within the sealed enclosure.

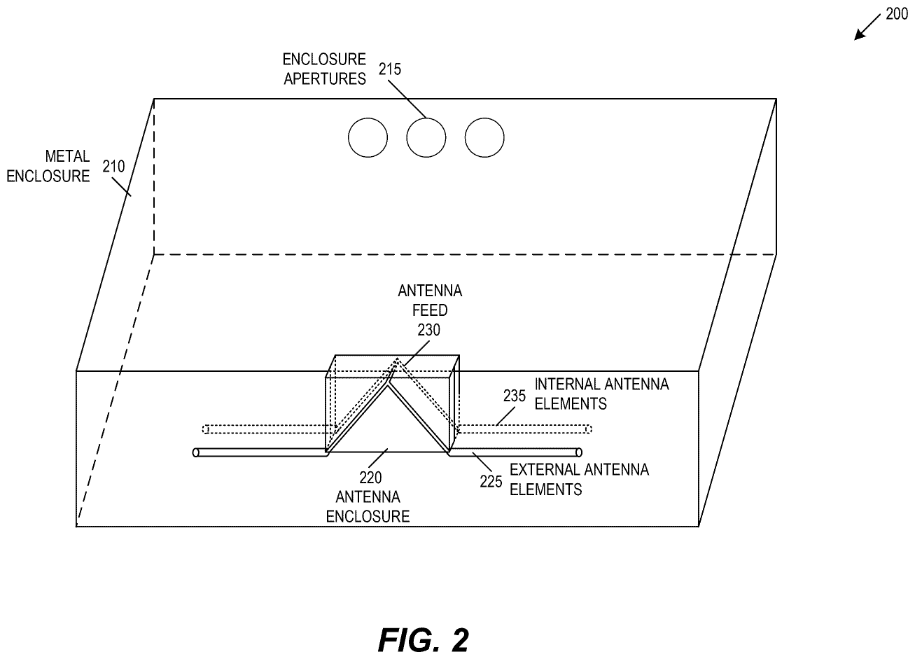

FIG. 2 illustrates a second example antenna system 200 for wireless communication through an RF-attenuating enclosure. As shown in FIG. 2, the antenna system 200 may be used to convey an RF signal into and out of a metal enclosure 210. The second example antenna system 200 includes an antenna enclosure 220 coupled to one or more external antenna elements 225. The external antenna elements 225 may be coupled through the antenna enclosure 220 and through an internal antenna feed 230 to internal antenna elements 235. The external antenna elements 225 and the internal antenna elements 235 may form a dipole antenna configuration. The external antenna elements 225 and the internal antenna elements 235 may form dipole antennas with substantially similar antenna geometries to provide substantially similar radiation patterns. In an example, for a UHF RFID system that operates around 900 MHz, the dipole antenna length may be selected to be half of the wavelength, or around 6.56 inches (16.66 cm). The use of a dipole antenna configuration may provide various advantages, such as design simplicity, reduced implementation cost, increased operating frequency range, and an omnidirectional radiation pattern. In another example, the external antenna elements 225 and internal antenna elements 235 may include radiating cables (e.g., leaky feeder coaxial cables) to send and receive RFID signals. The use of a reradiating cable configuration may provide various advantages, such as design simplicity, simplified installation (e.g., due to flexible cable), and improved continuous coverage along the cable (e.g., wrapped around an interior of metal enclosure 210).

In operation, wireless signals from an RFID reader or other external source outside the metal enclosure 210 are received by the external antenna elements 225. The external antenna elements 225 convey these wireless signals via the conductive antenna feed 230 to the internal antenna elements 235 located within the metal enclosure 210. The internal antenna elements 235 then reradiate the wireless signals internally within the metal enclosure 210 to an intended destination, such as RFID tags or other wireless devices contained within the enclosure. Return wireless signals from internal devices are similarly conveyed from the internal antenna elements 235 via the antenna feed 230 back to the external antenna elements 225 for transmission externally to the wireless source. The antenna system 200 thereby enables bidirectional wireless signal transmission into and out of the sealed metal enclosure 210.

The second example antenna system 200 and other antenna systems described herein provide various advantages for wireless communication through metal enclosure 210. In an example, the metal enclosure 210 may include a metal container used for surgical instrument sterilization. The surgical instrument sterilization may include subjecting the metal enclosure 210 and surgical instruments inside the metal enclosure 210 to a sterilization temperature range, where the sterilization temperature range includes 130°-140° centigrade or higher temperatures. The sterilization process may be tracked by an RFID-enabled device, such as a device that uses a temperature-responsive RFID circuit. In an example, the temperature-responsive RFID device includes phenacetin wick with a melting point around 133°-137° centigrade, where the melting of the phenacetin wick triggers (e.g., closes or opens) a circuit within the temperature-responsive RFID device. The temperature-responsive RFID device may be used to indicate whether the surgical instrument sterilization process has subjected the temperature-responsive RFID device and any surgical instruments within the metal enclosure 210 to a sufficient temperature for sterilization. By interrogating the temperature-responsive RFID device, an RFID reader may determine if the circuit has been triggered, indicating the sterilization procedure is complete.

The metal enclosure 210 may include one or more enclosure apertures 215 that enable passage of heat, water vapor, and other gasses during the sterilization procedure. However, the one or more enclosure apertures 215 may be too small to allow effective passage of RFID signals into and out of the metal enclosure 210. The metal enclosure 210 may act as a Faraday cage, substantially blocking external RF signals from reaching a temperature-responsive RFID device or other RFID devices inside the metal enclosure 210. The metal enclosure 210 prevents remotely reading RFID devices within the metal enclosure 210, such as to determine whether the sterilization procedure has completed. Opening the container to read the RFID devices would expose the sterile contents to contamination, which may require restarting the entire sterilization process and may require replacing the RFID device. By using the second example antenna system 200 and other antenna systems described herein to communicate to an RFID device within the metal enclosure 210, the sterilization process may be confirmed without opening the metal enclosure 210. If the metal enclosure 210 has undergone a sterilization process (e.g., subjected to water vapor at 130°-140° centigrade) but the RFID device indicates the sterilization process has not completed, then the metal enclosure 210 may be subjected to a shorter additional sterilization process to complete the sterilization. The temperature-responsive RFID device may include two or more temperature-responsive circuits, which may be used to indicate a sterilization progress status. In an example, the temperature-responsive RFID device may include a first circuit that indicates the temperature has reached approximately 120°, a second circuit to indicate 130°, and a third circuit to indicate 140°.

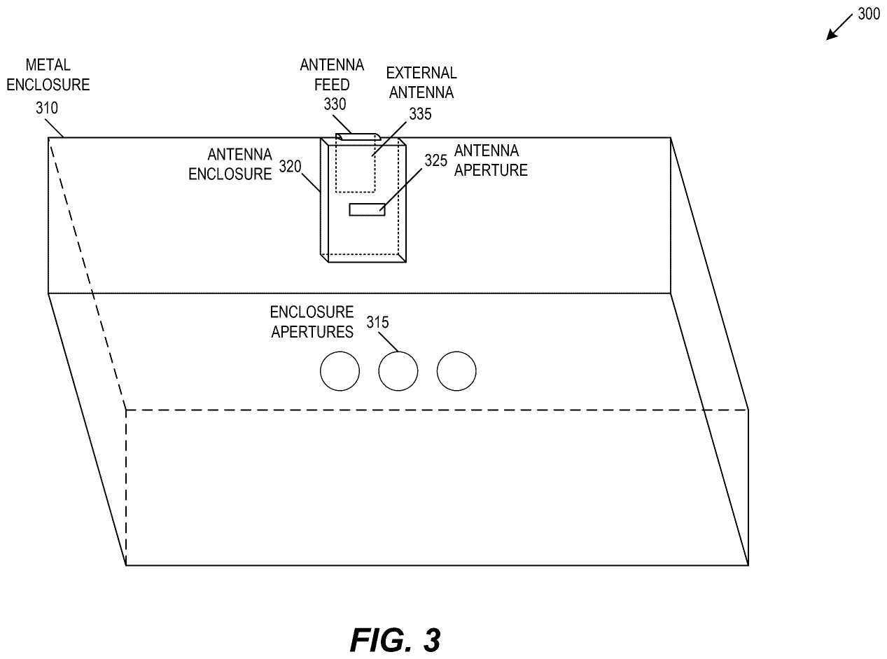

While the external antenna elements 225 are shown in FIG. 2 as coupled through internal antenna feed 230 to internal antenna elements 235, other types of antenna couplings may be used. The internal and external antennas may be coupled using capacitive or inductive coupling. In an example, the internal and external antennas may be coupled using capacitive coupling, and the antenna enclosure 220 may be formed from a dielectric material selected to improve or maximize capacitive coupling between the internal and external antennas. Another antenna configuration may include a cavity resonator, such as shown in FIG. 3.

FIG. 3 illustrates a third example antenna system 300 for wireless communication through an RF-attenuating enclosure. As shown in FIG. 3, the antenna system 300 may be used to convey an RF signal into and out of a metal enclosure 310. The third example antenna system 300 includes an antenna enclosure 320 disposed on an interior of the metal enclosure 310. The antenna enclosure 320 may include cavity resonator antenna with an antenna aperture 325 for radiating an RF signal. The antenna enclosure 320 may be coupled through an antenna feed 330 to an external antenna 335 disposed on an outside the metal enclosure 310.

In operation, wireless signals from an RFID reader or other external source outside the metal enclosure 310 are received by the external antenna 335. The external antenna 335 may convey these wireless signals via the conductive antenna feed 330 to the internal antenna enclosure 320 located within the metal enclosure 310. The internal antenna enclosure 320 then reradiate the wireless signals internally through the antenna aperture 325 within the metal enclosure 210 to an intended destination, such as RFID tags or other wireless devices contained within the enclosure. Return wireless signals from internal devices are similarly conveyed from the internal antenna enclosure 320 via the antenna feed 330 back to the external antenna 335 for transmission externally to the wireless source. The metal enclosure 310 may include one or more enclosure apertures 315 that may be too small to allow effective passage of RFID signals into and out of the metal enclosure 310. The antenna system 300 enables bidirectional wireless signal transmission into and out of the sealed metal enclosure 310.

The use of a cavity resonating configuration in the third example antenna system 300 may provide various advantages. A cavity resonator may provide an improved quality factor (Q-factor), which provides an increased level of selectivity at the resonant frequency selected for a particular RFID application (e.g., 13.56 MHz high-frequency RFID circuits). A cavity resonator may also provide improved radiation efficiency and improved radiation directionality, which may improve the ability of the antenna enclosure 320 to communicate with an RFID circuit in a predetermined location within the metal enclosure 310. Additionally, the location and geometry of the antenna aperture 325 may be selected to facilitate efficient wireless signal transfer at a desired RFID frequency or frequency band.

One or more of the first antenna system 100, second example antenna system 200, or the third example antenna system 300 may be implemented as a coupled passive antenna system. The use of coupled passive antennas provides various advantages. Passive antenna systems do not require an internal power source, which may avoid issues with implementing or maintaining batteries or electronics inside a high-temperature sterilization environment. For example, a passive antenna system may be fully sealed with no openings to compromise sterility. Passive antenna systems may also be implemented with fewer components at a lower cost than an active antenna system. While the passive antenna system may not use power for its functionality, the passive antenna system may radiate the RFID signal with sufficient power to energize an RFID tag inside the enclosure and enable the RFID tag to create and broadcast the return RFID signal. This may enable both the passive antenna system and the RFID tag to be implemented without requiring an internal power source.

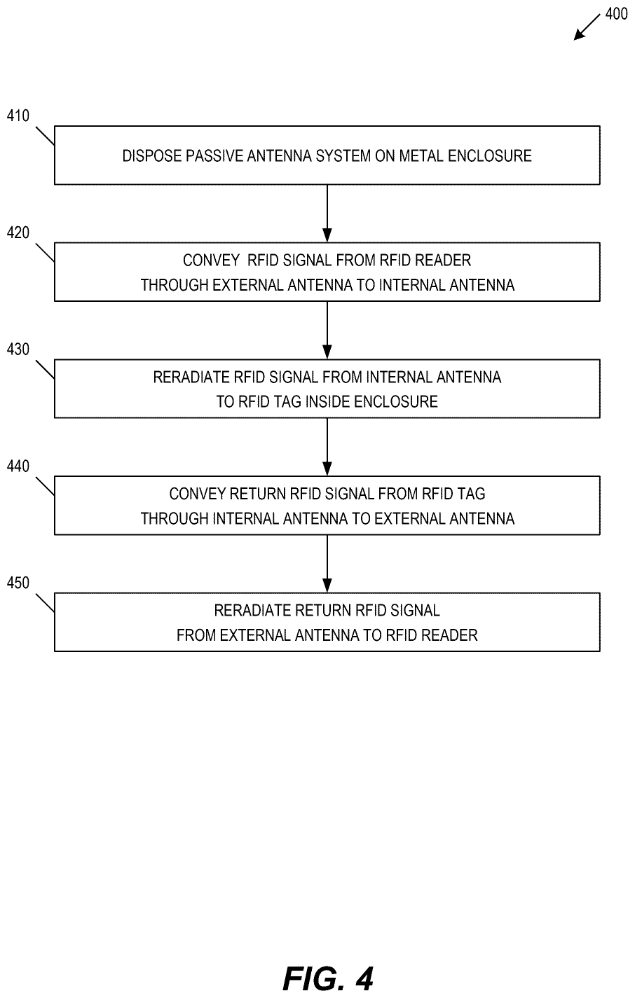

FIG. 4 illustrates an example method 400 for reading RFID tags inside a metal enclosure. Method 400 includes disposing 410 a passive antenna system on the metal enclosure. The passive antenna system includes an external antenna disposed outside a metal enclosure, an internal antenna disposed inside the metal enclosure, and a coupler between the external antenna and the internal antenna. The coupler is configured to convey RF signals between the external antenna and the internal antenna.

Method 400 includes conveying 420 an RFID signal at the external antenna from an RFID reader positioned outside the metal enclosure through the coupler to the internal antenna. Method 400 includes reradiating 430 the RFID signal from the internal antenna to an RFID tag inside the metal enclosure. Method 400 includes conveying 440 a return RFID signal from the RFID tag through the coupler to the external antenna. The return RFID signal may include a backscatter-modulated RFID signal. Method 400 includes reradiating 450 the return RFID signal from the external antenna to the RFID reader.

The coupling between the external antenna and the internal antenna may include at least one of conductive coupling, capacitive coupling, or inductive coupling. In some examples, the coupler may include an insulating dielectric material disposed on a conductive portion of the coupler. The coupler may include a dielectric material selected to reflect the RF signals within the coupler. The insulator material may be selected to withstand a temperature range associated with medical instrument sterilization, such as temperatures above 130° centigrade.

In an example, the external antenna includes a first wire dipole antenna, and the internal antenna may include a second wire dipole antenna. In another example, the external antenna includes a first multi-turn antenna coil, and the internal antenna includes a second multi-turn antenna coil. In another example, the external antenna and internal antenna include leaky coaxial cables, which may include RF radiating slots in a coaxial cable shielding, which allow the RF signals to radiate into and out of the metal enclosure through the slots. In yet another example, the internal antenna includes a cavity resonator, and the coupler may include a feed line between the internal antenna and the RFID tag inside the metal enclosure.

The internal antenna and the external antenna may be tuned to a predetermined RFID frequency or RFID frequency range. The RFID frequency range may include at least one of a low-frequency RFID range between 125 kHz and 148.5 kHz or a high-frequency RFID frequency of approximately 13.56 MHz.

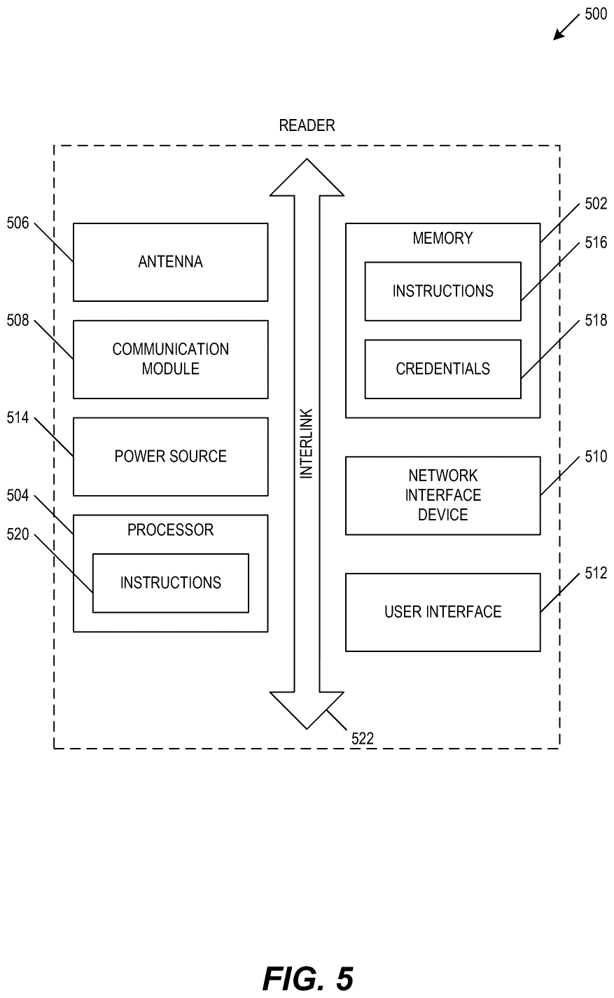

FIG. 5 illustrates a block diagram schematic of various components of an example reader 500, such as may be used with the antenna systems and methods discussed herein. In general, reader 500 can include one or more of a memory 502, a processor 504, one or more antennas 506, a communication module 508, a network interface device 510, a user interface 512, and a power source 514 (e.g., power supply). Reader 500 may include a device affixed to a surface (e.g., wall, door), though reader 500 may also be a free-standing device or a portable device (e.g., mobile electronic device).

Memory 502 can be used in connection with the execution of application programming or instructions by processor 504, and for the temporary or long-term storage of executable instructions 516 (e.g., program instructions, program instruction sets) or credential or authorization data 518, such as credential data, credential authorization data, or access control data or instructions. For example, memory 502 can contain executable instructions 516 that are used by the processor 504 to run other components of reader 500 and make access determinations based on credential or authorization data 518. Memory 502 can comprise a computer readable medium that can be any medium that can contain, store, communicate, or transport data, program code, or instructions for use by or in connection with reader 500. The computer readable medium can be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or EEPROM), Dynamic RAM (DRAM), any solid-state storage device, in general, a compact disc read-only memory (CD-ROM), or other optical or magnetic storage device. Computer readable media includes, but is not to be confused with, computer readable storage medium, which is intended to cover all physical, non-transitory, or similar embodiments of computer readable media.

Processor 504 can correspond to one or more computer processing devices or resources. For instance, processor 504 can be provided as silicon, as a Field Programmable Gate Array (FPGA), an Application-Specific Integrated Circuit (ASIC), any other type of Integrated Circuit (IC) chip, a collection of IC chips, or the like. As a more specific example, processor 504 can be provided as a microprocessor, Central Processing Unit (CPU), or plurality of microprocessors or CPUs that are configured to execute instructions sets stored in an internal memory 520 or memory 502.

Antenna 506 can correspond to one or multiple antennas and can be configured to provide for wireless communications between, for example, reader 500 and a credential or key device. Antenna(s) 506 can be arranged to operate using one or more wireless communication protocols and operating frequencies such as the IEEE 802.15.1, Bluetooth, Bluetooth Low Energy (BLE), near field communications (NFC), ZigBee, GSM, CDMA, Wi-Fi, RF, UWB, and the like. By way of example, antenna(s) 506 can be RF antenna(s), and as such, may transmit or receive RF signals through free space to be received/transferred by a credential or key device having an RF transceiver.

Communication module 508 can be configured to communicate according to any suitable communications protocol with one or more different systems or devices either remote or local to reader 500, such as a control panel or external control device.

Network interface device 510 includes hardware to facilitate communications with other devices, such as a control panel or host server over a communication network, using any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, wireless data networks (e.g., IEEE 802.11 family of standards known as Wi-Fi or IEEE 802.16 family of standards known as WiMax), networks based on the IEEE 802.15.4 family of standards, and peer-to-peer (P2P) networks, among others. In some examples, network interface device 510 can include an Ethernet port or other physical jack, a Wi-Fi card, a Network Interface Card (NIC), a cellular interface (e.g., antenna, filters, and associated circuitry), or the like. In some examples, network interface device 510 can include one or more antennas to wirelessly communicate using, for example, at least one of single-input multiple-output (SIMO), multiple-input multiple-output (MIMO), or multiple-input single-output (MISO) techniques.

User interface 512 can include one or more input devices or display devices. Examples of suitable user input devices that can be included in user interface 512 include, without limitation, one or more buttons, a keyboard, a mouse, a touch-sensitive surface, a stylus, a camera, a microphone, a PIN pad, touch screen, fingerprint reader, magnetic stripe reader, chip reader, etc. Examples of suitable user output devices that can be included in user interface 512 include, without limitation, one or more LEDs, an LCD panel, a display screen, a touchscreen, one or more lights, a speaker, etc. It should be appreciated that user interface 512 can also include a combined user input and user output device, such as a touch-sensitive display or the like.

Power source 514 can be any suitable internal power source, such as a battery, capacitive power source or similar type of charge-storage device, etc., or can include one or more power conversion circuits suitable to convert external power into suitable power (e.g., conversion of externally supplied AC power into DC power) for components of the reader 500. Power source 514 can also include some implementation of surge protection circuitry to protect the components of reader 500 from power surges.

Reader 500 can also include one or more busses or interlinks 522 operable to transmit communications between the various hardware components of the reader. A system bus or interlink 522 can be any of several types of commercially available bus structures or bus architectures. A computing device or credential reader manager may reconfigure the reader 500 by connecting a device to the reader 500 via bus or interlink 522, such as by changing device parameters (e.g., configurable interpolling delays), by overwriting a device management policy, by updating software, by reflashing firmware, or other reconfigurations.

### Additional Examples

Example 1 is a passive antenna system for reading radio frequency tags inside a metal enclosure, the passive antenna system comprising: an external antenna disposed outside a metal enclosure; an internal antenna disposed inside the metal enclosure; a coupler between the external antenna and the internal antenna, the coupler configured to convey radio frequency (RF) signals between the external antenna and the internal antenna; wherein the external antenna is configured to convey an RF identification (RFID) signal from an RFID reader positioned outside the metal enclosure through the coupler to the internal antenna; and wherein the internal antenna is configured to reradiate the RFID signal to an RFID tag inside the metal enclosure, receive a return RFID signal from the RFID tag, and couple the return RFID signal to the external antenna.

In Example 2, the subject matter of Example 1 includes an insulator disposed on the coupler.

In Example 3, the subject matter of Example 2 includes wherein the insulator includes a dielectric material selected to reflect the RF signals within the coupler.

In Example 4, the subject matter of Examples 2-3 includes wherein an insulator material is selected to withstand a temperature range associated with medical instrument sterilization.

In Example 5, the subject matter of Example 4 includes wherein the temperature range includes temperatures above 130° centigrade.

In Example 6, the subject matter of Examples 1-5 includes wherein the return RFID signal includes a backscatter-modulated RFID signal.

In Example 7, the subject matter of Examples 1-6 includes wherein the coupler provides conductive coupling between the external antenna and the internal antenna.

In Example 8, the subject matter of Examples 1-7 includes wherein the coupler provides capacitive coupling between the external antenna and the internal antenna.

In Example 9, the subject matter of Examples 1-8 includes wherein: the external antenna includes a first wire dipole antenna; and the internal antenna includes a second wire dipole antenna.

In Example 10, the subject matter of Examples 1-9 includes wherein: the external antenna includes a first multi-turn antenna coil; and the internal antenna includes a second multi-turn antenna coil.

In Example 11, the subject matter of Examples 1-10 includes wherein the external antenna and the internal antenna are tuned to a predetermined RFID frequency band.

In Example 12, the subject matter of Examples 1-11 includes wherein the internal antenna is configured to receive power from the external antenna via the coupler to power the RFID tag inside the metal enclosure.

In Example 13, the subject matter of Examples 1-12 includes wherein: the metal enclosure substantially attenuates signals in an RFID frequency range; and the external antenna, internal antenna, and coupler are configured to communicate signals in the RFID frequency range to enable wireless communication through the metal enclosure.

In Example 14, the subject matter of Example 13 includes wherein the RFID frequency range includes at least one of a low-frequency RFID range between 125 kHz and 148.5 kHz or a high-frequency RFID range of approximately 13.56 MHz.

In Example 15, the subject matter of Examples 1-14 includes wherein the external antenna and internal antenna include leaky coaxial cables with RF radiating slots in a coaxial cable shielding to allow the RF signals to radiate into and out of the metal enclosure.

In Example 16, the subject matter of Examples 1-15 includes wherein: the internal antenna includes a cavity resonator; and the coupler includes a conductive trace conductively coupled between the cavity resonator and the external antenna.

In Example 17, the subject matter of Examples 1-16 includes a direct conductive feed line coupled between the internal antenna and the RFID tag inside the metal enclosure.

Example 18 is a method for reading radio frequency tags inside a metal enclosure, the method comprising: disposing an external antenna outside a metal enclosure; disposing an internal antenna inside the metal enclosure; coupling the external antenna and the internal antenna with a coupler configured to convey radio frequency (RF) signals between the external antenna and the internal antenna; conveying, via the external antenna and the coupler, an RF identification (RFID) signal from an RFID reader positioned outside the metal enclosure to the internal antenna; reradiating, via the internal antenna, the RFID signal to an RFID tag disposed inside the metal enclosure; receiving, via the internal antenna, a return RFID signal from the RFID tag; coupling the return RFID signal from the internal antenna to the external antenna.

In Example 19, the subject matter of Example 18 includes disposing an insulator on the coupler.

In Example 20, the subject matter of Example 19 includes wherein the insulator includes a dielectric material selected to reflect the RF signals within the coupler.

In Example 21, the subject matter of Examples 19-20 includes selecting an insulator material configured to withstand a temperature range associated with medical instrument sterilization.

In Example 22, the subject matter of Example 21 includes wherein the temperature range includes temperatures above 130 degrees centigrade.

In Example 23, the subject matter of Examples 18-22 includes wherein receiving the return RFID signal includes receiving a backscatter-modulated RFID signal.

In Example 24, the subject matter of Examples 18-23 includes wherein coupling includes providing conductive coupling between the external antenna and the internal antenna.

In Example 25, the subject matter of Examples 18-24 includes wherein coupling includes providing capacitive coupling between the external antenna and the internal antenna.

In Example 26, the subject matter of Examples 18-25 includes configuring the external antenna as a first wire dipole antenna; configuring the internal antenna as a second wire dipole antenna.

In Example 27, the subject matter of Examples 18-26 includes configuring the external antenna to include a first multi-turn antenna coil; configuring the internal antenna to include a second multi-turn antenna coil.

In Example 28, the subject matter of Examples 18-27 includes tuning the external antenna and the internal antenna to a predetermined RFID frequency band.

In Example 29, the subject matter of Examples 18-28 includes providing power from the external antenna to the internal antenna via the coupler to power the RFID tag inside the metal enclosure.

In Example 30, the subject matter of Examples 18-29 includes wherein: the metal enclosure substantially attenuates signals in an RFID frequency range; and configuring the external antenna, internal antenna, and coupler to communicate signals in the RFID frequency range to enable wireless communication through the metal enclosure.

In Example 31, the subject matter of Example 30 includes wherein the RFID frequency range includes at least one of a low-frequency RFID range between 125 kHz and 148.5 kHz or a high-frequency RFID range of approximately 13.56 MHz.

In Example 32, the subject matter of Examples 18-31 includes configuring the external antenna and internal antenna to include leaky coaxial cables with RF radiating slots in a coaxial cable shielding; allowing the RF signals to radiate into and out of the metal enclosure through the slots.

In Example 33, the subject matter of Examples 18-32 includes configuring the internal antenna as a cavity resonator; conductively coupling a conductive trace between the cavity resonator and the external antenna.

In Example 34, the subject matter of Examples 18-33 includes coupling a direct conductive feed line between the internal antenna and the RFID tag inside the metal enclosure.

Example 35 is at least one machine-readable medium including instructions that, when executed by processing circuitry, cause the processing circuitry to perform operations to implement of any of Examples 1-34.

Example 36 is an apparatus comprising means to implement of any of Examples 1-34.

Example 37 is a system to implement of any of Examples 1-34.

Example 38 is a method to implement of any of Examples 1-34.

### Additional Notes

The above detailed description includes references to the accompanying drawings, which form a part of the detailed description. The drawings show, by way of illustration, specific embodiments that can be practiced. These embodiments may also be referred to herein as “examples.” Such embodiments or examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein. That is, the above-described embodiments or examples or one or more aspects, features, or elements thereof can be used in combination with each other.

As will be appreciated by one of skill in the art, the various embodiments of the present disclosure may be embodied as a method (including, for example, a computer-implemented process, a business process, or any other process), apparatus (including, for example, a system, machine, device, computer program product, or the like), or a combination of the foregoing. Accordingly, embodiments of the present disclosure or portions thereof may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. In the context of this disclosure, a computer readable medium may be any medium that can contain, store, communicate, or transport the program for use by or in connection with the systems disclosed herein. As indicated above, the computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical, magnetic, or solid state storage device. As noted above, computer-readable media includes, but is not to be confused with, computer-readable storage medium, which is intended to cover all physical, non-transitory, or similar embodiments of computer-readable media.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A passive antenna system for reading radio frequency tags inside a metal enclosure, the passive antenna system comprising:
an external antenna disposed outside a metal enclosure;
an internal antenna disposed inside the metal enclosure;
a coupler between the external antenna and the internal antenna, the coupler configured to convey radio frequency (RF) signals between the external antenna and the internal antenna;
wherein the external antenna is configured to convey an RF identification (RFID) signal from an RFID reader positioned outside the metal enclosure through the coupler to the internal antenna; and
wherein the internal antenna is configured to reradiate the RFID signal to an RFID tag inside the metal enclosure, receive a return RFID signal from the RFID tag, and couple the return RFID signal to the external antenna.

2. The passive antenna system of claim 1, further including an insulator disposed on the coupler.

3. The passive antenna system of claim 2, wherein the insulator includes a dielectric material selected to reflect the RF signals within the coupler.

4. The passive antenna system of claim 1, wherein:
the external antenna includes a first wire dipole antenna; and
the internal antenna includes a second wire dipole antenna.

5. The passive antenna system of claim 1, wherein:
the external antenna includes a first multi-turn antenna coil; and
the internal antenna includes a second multi-turn antenna coil.

6. The passive antenna system of claim 1, wherein the external antenna and the internal antenna are tuned to a predetermined RFID frequency band.

7. The passive antenna system of claim 1, wherein the internal antenna is configured to receive power from the external antenna via the coupler to power the RFID tag inside the metal enclosure.

8. The passive antenna system of claim 1, wherein:
the metal enclosure substantially attenuates signals in an RFID frequency range; and
the external antenna, internal antenna, and coupler are configured to communicate signals in the RFID frequency range to enable wireless communication through the metal enclosure.

9. The passive antenna system of claim 1, wherein the external antenna and internal antenna include leaky coaxial cables with RF radiating slots in a coaxial cable shielding to allow the RF signals to radiate into and out of the metal enclosure.

10. The passive antenna system of claim 1, wherein:
the internal antenna includes a cavity resonator; and
the coupler includes a conductive trace conductively coupled between the cavity resonator and the external antenna.

11. The passive antenna system of claim 1, further including a direct conductive feed line coupled between the internal antenna and the RFID tag inside the metal enclosure.

12. A method for reading radio frequency tags inside a metal enclosure, the method comprising:
disposing an external antenna outside a metal enclosure;
disposing an internal antenna inside the metal enclosure;
coupling the external antenna and the internal antenna with a coupler configured to convey radio frequency (RF) signals between the external antenna and the internal antenna;
conveying, via the external antenna and the coupler, an RF identification (RFID) signal from an RFID reader positioned outside the metal enclosure to the internal antenna;
reradiating, via the internal antenna, the RFID signal to an RFID tag disposed inside the metal enclosure;
receiving, via the internal antenna, a return RFID signal from the RFID tag;
coupling the return RFID signal from the internal antenna to the external antenna.

13. The method of claim 12, further comprising disposing an insulator on the coupler.

14. The method of claim 13, wherein the insulator includes a dielectric material selected to reflect the RF signals within the coupler.

15. The method of claim 12, further comprising:
configuring the external antenna as a first wire dipole antenna;
configuring the internal antenna as a second wire dipole antenna.

16. The method of claim 12, further comprising:
configuring the external antenna to include a first multi-turn antenna coil;
configuring the internal antenna to include a second multi-turn antenna coil.

17. The method of claim 12, further comprising providing power from the external antenna to the internal antenna via the coupler to power the RFID tag inside the metal enclosure.

18. The method of claim 12, wherein:
the metal enclosure substantially attenuates signals in an RFID frequency range; and
configuring the external antenna, internal antenna, and coupler to communicate signals in the RFID frequency range to enable wireless communication through the metal enclosure.

19. The method of claim 12, further comprising:
configuring the external antenna and internal antenna to include leaky coaxial cables with RF radiating slots in a coaxial cable shielding;
allowing the RF signals to radiate into and out of the metal enclosure through the slots.

20. The method of claim 12, further comprising:
configuring the internal antenna as a cavity resonator;
conductively coupling a conductive trace between the cavity resonator and the external antenna.
